(19) United States
(12) Patent Application Publication
(10) Pub. No.: US 2024/0195831 A1
(43) Pub. Date: Jun. 13, 2024

(54) METHOD, PRODUCT, AND SYSTEM FOR TRANSLATING ENTITY PRIORITIZATION RULES TO A CONTINUOUS NUMERICAL SPACE

(71) Applicant: Vectra AI, Inc., San Jose, CA (US)

(72) Inventors: Daniel Carlton Hannah, Melrose, MA (US); Himanshu Mhatre, Mountain View, CA (US); Sohrob Kazerounian, Brookline, MA (US); Timothy John Wade, Gilbert, AZ (US); Karl Lynn, San Jose, CA (US); Stephen Malone, Milltown (IE)

(73) Assignee: Vectra AI, Inc., San Jose, CA (US)

(21) Appl. No.: 18/525,702

(22) Filed: Nov. 30, 2023

Related U.S. Application Data
(60) Provisional application No. 63/431,420, filed on Dec. 9, 2022.

(51) Int. Cl. H04L 9/40

(52) U.S. Cl. CPC H04L 63/1441; H04L 63/20

(57) ABSTRACT

Disclosed is an improved approach for translating entity prioritization rules to a continuous numerical space. In some embodiments, the approach provided is a system for using qualitative prioritization criteria to train a system that generates quantitative urgency scores for entities. In some embodiments, this comprises an embedding scheme that enables the translation of entity information and their related alerts to a set of qualitative labels based on at least quantitative information. Generally, the system includes a set of analyst actions that establish desired mappings which are used to train a more general model that maps entity embeddings to responses. In some embodiments, the approach comprises one or more models that receive an entity embedding as an input and outputs a score that characterizes the urgency of the response warranted for that entity. In some embodiments, this is performed using various features (e.g., importance, actor type, velocity, and breadth).

### CONTINUATION INFORMATION

This disclosure is a continuation of U.S. Provisional App. Ser. No. 63/431,420 entitled “METHOD, PRODUCT, AND SYSTEM FOR TRANSLATING ENTITY PRIORITIZATION RULES TO A CONTINUOUS NUMERICAL SPACE,” filed on Dec. 9, 2022. The content of the aforementioned U.S. patent application is hereby explicitly incorporated by reference for all purposes.

### BACKGROUND

Understanding the network environment and the interaction between entities is crucial to guarding the security of the network. There are several reasons that cause this task to be very difficult. For instance, as the volume of network traffic has exploded so has the amount of data corresponding to activities associated with security risks and breaches. Unfortunately, this has made it difficult for security professionals and others to keep up with the generally massive workload required to monitor networks.

Threat classification platforms used to monitor networks are continually plagued with a constant flow of security events alerting cybersecurity threat responders with potentially unsanctioned behavior in their computer networks, cloud infrastructure, and software as a service (SAAS) applications. Many of these alerts may correspond to generally undesirable behavior, but may not in actuality be part of an active attack campaign from an adverse party (e.g., alerts may correspond to an internal process necessary for maintenance of the network). None-the-less, these alerts can pose a serious distraction for responders whose first priority is to stop advancement of active threats. However, separating alerts corresponding to an actual threat from alerts corresponding to generally undesirable but otherwise benign behavior traditionally requires a human expert with strong domain familiarity and can be a very resource intensive.

For example, there are enormous numbers of entities (accounts/hosts/services) within networks interacting with each other. Many of these interactions may be normal and may not otherwise correspond to undesirable behavior. However, in most networks a vast amount of these interactions may correspond to generally undesirable but not malicious behavior—e.g., the behaviors are generally benign. Additionally, it is likely that at least some of these interactions correspond to malicious behavior (e.g., data theft related activities). In order to detect the malicious behavior most systems implement monitoring protocols that generate alerts for review by a security professional (e.g., an administrator) to identify which are merely generally undesirable and which are actually malicious behavior.

One way that this is addressed is to focus on an entity rather than individual alerts. To do so currently, analysts (e.g., those with domain knowledge) apply qualitative information to determine whether an entity should be investigated further. Such information might include how the entity fits into the network, when was a corresponding alert triggered and does the timing suggest malicious behavior, and do other alerts associated with that entity suggest a broader malicious pattern in view of currently-known information. Unfortunately, while qualitative processes like this are generally effective, their effectiveness breaks down as the number of entities on a network increase. In fact, it is common that the number of entities on a network is simply too great for the available number of analysts with the required domain knowledge. As a result, it is difficult to scale such qualitative analysis.

Thus, what is needed is a way to provide the desired qualitative information in a quantitative manner that can be scaled.

### SUMMARY

In some embodiments, the approach provides for a method, product, and system for translating entity prioritization rules to a continuous numerical space. In some embodiments, the approach provided is a system for using qualitative prioritization criteria to train a system that generates quantitative urgency scores for entities (hosts and accounts) in a computer network. In some embodiments, this comprises an embedding scheme that enables the translation of entity information and their related alerts to a fixed set of qualitative labels based on at least quantitative information. In some embodiments, an embedding scheme is provided for the types of actions an analyst can apply to an entity. For example, an entity may be determined to be a specific type of actor and based on at least a given action, where an operational response might be executed to mitigate a perceived threat or undesirable action. Generally, the system includes a set of analyst actions that establish desired mappings (actor type+alerts may be mapped to a desired operational response), which are used to train a more general model that maps entity embeddings to responses. In some embodiments, the approach comprises one or more models that receive an entity embedding as an input and outputs a score that characterizes the urgency of the response warranted for that entity. In some embodiments, this is performed using various features (e.g., importance, actor type, velocity, and breadth). In some embodiments, a group of entities can be treated as a single entity for analysis, where the actions of the multiple entities are attributed to a single actor (e.g., attacker, person, or organization).

Further details of aspects, objects, and advantages of some embodiments are described below in the detailed description, drawings, and claims. Both the foregoing general description and the following detailed description are exemplary and explanatory and are not intended to be limiting as to the scope of the embodiments.

### BRIEF DESCRIPTION OF THE DRAWINGS

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. These drawings depict only typical embodiments of the invention and are not therefore to be considered limiting of its scope, the invention will be described and explained with additional specificity and detail using the accompanying drawings.

FIG. 1 illustrates an example environment(s) in which some embodiments of the invention are implemented.

FIG. 2 illustrates a process flow according to some embodiments of the invention.

FIG. 3 provides logical illustration of the approach provided herein according to some embodiments of the invention.

FIG. 4A illustrates an operational view of an approach to generate a constraint solution as provided herein according to some embodiments of the invention.

FIG. 4B illustrates an operational view of an approach to determine urgency for an entity based on a constraint solution as provided herein according to some embodiments of the invention.

FIG. 5 is a block diagram of an illustrative computing system suitable for implementing an embodiment of the present invention.

### DETAILED DESCRIPTION

Various embodiments of the invention are directed to a method, product, and system for translating entity prioritization rules to a continuous numerical space.

In some embodiments, the approach provides a constraint solver that uses a set of rules to determine valid values for four features (e.g., actor type, importance, velocity, breadth). Generally, the rules may be provided by domain experts. For example, a domain expert might indicate that they always investigate a critical asset if it had any detections. From this we might determine that there is a recommended outcome (investigate) when a critical asset is associated with an alert (e.g., actor type=any, importance=high/critical, velocity=any, breadth=any, and outcome—investigate). In some embodiments, this determination is performed by a human or comprises domain expert translating their own thoughts into a rule. In some embodiments, such statements are processed using natural language or linguistic processing techniques to identify relevant features and their corresponding values.

In some embodiments, the domain expert knowledge is maintained as a set of rules representing qualitative expressions of how that domain expert would normally respond to different situations.

In some embodiments, the features may comprise any of actor type, importance, velocity, and breadth. Actor type may comprise any classification of an entity (e.g., account or host) that is known in the art or may comprise a classification of a person or group of people controlling the entity or multiple entities. For example, actor type may comprise one or more of an external adversary, ransomware, privileged insider threat, non-privileged insider threat, botnet, vulnerability scanner, IT discovery, IT services, cloud services, or potentially unwanted program. Actor types may be provided from another source e.g., based on a different classification system or set of rules. For instance, MITRE cyber-attack technique identifiers (known as T-numbers) are assigned to respective alert types present in the system. Subsequently, when an alert is received or an entity or group of entities are to be processed, the corresponding T-numbers are fed through a set of logic (e.g., if-then-else statements) that translate combinations of T-numbers to actor types.

If, for example, a host triggers four alerts (port scanning (T-1595), remote procedure call sweeping (T-1595), gathering internal data (T-1074), and SQL injection (T-1190)), then a list of techniques triggered by the actor can be created (T-1595, T-1074, and T-1190). The list of techniques can then be fed into the set of logic to determine an actor type—e.g., privileged insider threat. In some embodiments, multiple actor types are assigned to an entity or group.

In some embodiments, the breadth feature describes the diversity of behaviors exhibited by the collection of alerts related to an entity or a corresponding group (herein entity/group). Here, each individual alert has a category. For instance, the system might use five categories: Command & Control, Botnet, Reconnaissance, Lateral Movement, or Exfiltration. Using such categories, or others, entity/group behavior can be classified numerically (e.g., based on a ratio of categories that match behavior of the entity/group or based on a number of categories that the user behavior falls into). For example, breadth could be placed into three levels where each level as follows: low (the entity/group has triggered alerts from only one of the categories), medium (the entity/group has triggered alerts from two of the above categories), or high (the entity/group has triggered alerts from three or more of the categories.)

In some embodiments, the velocity feature is a measure of how quickly an entity/group is triggering new types of alerts. Velocity can be directly related to the number of alert types that have been triggered in a time window. Similar to breadth, velocity can be quantified by a number (e.g., a ratio, count, or categorization). For example, an entity/group might have a low velocity when they triggered two or fewer types of alerts in the past 24 hours, a medium velocity when they triggered three or more types of alerts in the past 24 hours, or a high velocity when they triggered three or more types of alerts in the past 2 hours.

In some embodiments, the importance of an entity/group is determined based on a user input. In some embodiments, the importance of an entity/group is determined based on a default rule (e.g., domain controllers are automatically of high or the highest importance). In some embodiments, an entity/group is assigned a default importance (e.g., medium importance) when no importance is provided. In some embodiments, the importance of an entity/group is determined using an automatic system that uses observed network traffic to generate an importance.

In some embodiments, the above set of known information can be used to determine feature values for respective entities/groups. Additionally, a set of analyst actions, or captured domain specific knowledge, can be used to map the feature values to different urgency values. For example, if a three-zone classification is used (e.g., wait and watch, investigate, investigate immediately) the feature values can be used to map a corresponding entity/group into a corresponding urgency position. By doing this, the approach sets up a set of functions (e.g., inequalities) that are to be mapped to a result without providing the specifics (e.g., the contribution of each aspect) to solve the set of functions. These specifics can be determined using a constraint solver. If a constraint solution is successfully found, then the weights provided will guarantee a result that is not inconsistent with the provided functions.

In some embodiments, actor type indicates what behavioral profile is implied by the collection of alerts related to an entity/group; breadth indicates the level of diversity of the set of alerts related to the entity/group; velocity indicates how quickly the entity/group is triggering different types of alerts; and importance indicates how important the entity/groups is with regard to the environment where it resides.

In some embodiments, operational responses are coarsely categorized into three categories watch and wait: no immediate action required; investigate at earliest reasonable opportunity: more urgent operations should not be interrupted but this event should be investigated eventually; and investigate immediately: these events warrant immediate attention, even at the expense of investigating less urgent events.

In some embodiments, to determine the urgency a formula is used (e.g., Urgency(actor, velocity, breadth, importance)=c1*Importance+c2*actor type+c3*velocity+c4*breadth), where urgency is a function of each of an actor type, velocity, breadth, and importance, where each is multiplied by a corresponding coefficient (e.g., 1 or another number determined by the constraint solver). Here, each coefficient is essentially a weighting parameter that can be used to control the relative contribution of each feature. In some embodiments, one or more boundaries can be defined using thresholds. For example, T₁: Numerical boundary between “watch and wait” and “investigate”, and T₂: Numerical boundary between “investigate eventually” and “investigate immediately”. Additionally, the relationship between T₁ and T₂ could be defined (e.g., T₂>T₁, T₂>2*T₁ etc.).

A set of rules are also defined to determine which circumstances correspond to which actions. For example, Table 1 below illustrates circumstances A-D and their corresponding response urgency.

TABLE 1

| ID | Actor Type | Breadth | Velocity | Importance | Response |
|---|---|---|---|---|---|
| A | Cloud services | Medium | Low | Medium | Watch and |
| | | | | | wait |
| B | Insider threat | Low | Medium | Medium | Investigate |
| C | External | Medium | Medium | High | Investigate |
| | adversary | | | | immediately |
| D | Cloud Services | Low | Medium | High | Investigate |

Logically, these scenarios could be represented as a set of inequalities:

C1*Medium Importance+C2*Cloud Services+C3*Low velocity+C4*Medium breadth<T₁ A.

T₂>C1*Medium Importance+C2*insider threat+C3*Medium velocity+C4*Low breadth>T₁ B.

C1*High Importance+C2*External Adversary+C3*Med. velocity+C4*Med. breadth>T₂ C.

T₂>c1*High Importance+C2*Cloud Service+C3*Low velocity+C4*Medium breadth>T₁ D.

While only four examples are provided above, numerous entries could be provided and represented as a set of inequalities. This would be used by the constraint solver to generate an output.

In some embodiments, entities/groups may be ordered with respect to each other. For example, inequalities could be provided that relate characteristics of different classifications. For instance, suppose that an actor type of insider threat operating on a medium importance asset is more urgent than a high importance asset classified as a cloud service. This could be represented as an inequality as follows: C1*High Importance+C2*Cloud Services<C1*Medium Importance+C2*Insider Threat. Additionally, any of the features discussed herein could be included in such an equation and thereby provide an approach to enable sorting of entities/groups with respect to their urgency of review, even within the specified categories.

Generally, the function of the constraint solver is to solve a system of equations by processing received inputs and to solve for each value therein. Thus, using the low, medium, high approach discussed herein, for each feature a value representing the contribution of each feature in each classification is determined along with the threshold values (T1 and T2) and the coefficients (C1, C2, C3, and C4). For instance, the constraint solver might determine the following low/medium/high values for importance (10, 20, 30)+actor type (e.g., scanner=2, APT(12), etc.)*velocity(0/5/10)+breadth(2/5/7)). Additionally, the coefficients might be determined to be C1=2, C2=C3=C4=1. With each value determined, any of the entities/groups can be analyzed (as represented by a corresponding time period of a dataset) to determine what urgency level should be assigned to them, and in some embodiments, their relative rankings within a given urgency level.

Generally, the approaches provided herein may be used to process entities/groups corresponding to accounts and at least hosts based on corresponding alerts to generate a classification as to an urgency of investigation of the entity/group, where a more urgent identification indicates that the entity/group is more likely to be a compromised by a malicious actor(s) on the network.

In some embodiments, the approach is for translating entity prioritization rules to a continuous numerical space and comprises maintaining a plurality of alerts stored in an alert history, receiving a collection of rules for determining urgency of entities, determine a constraint solution for entity to urgency classification based on the collection of rules; and applying the constraint solution to an entity prioritization task to determine an entity prioritization, wherein the entity prioritization task processes one or more alerts of the plurality of alerts corresponding to the entity.

In some embodiments, the collection of rules comprises inequality statements mapping one or more features to an entity prioritization, and the entity prioritization corresponds to the urgency classification. Furthermore, in some embodiments, the inequality statements are generated using machine learning approaches such as latent semantic analysis of statements from one or more domain experts to generate inequalities to be solved by the constraint solver.

In some embodiments, the constraint solution is generated by a constraint solver that solves for the collection of rules, and the collection of rules associates one or more of an actor type, breadth, velocity, or importance to an urgency classification using one or more inequality statements. In some embodiments, actor type comprises a characterization of a behavioral intent of an actor and is determined using one or more MITRE cyber-attack technique identifiers (T-numbers); breadth comprises a low, medium, or high classification of a diversity of behaviors of an entity and is determined using one or more equations that map a number of categories of alerts for a corresponding entity to a breadth classification; velocity comprises a low, medium, or high classification of how quickly an entity is triggering alerts and is determined using one or more equations that map a number of categories triggered in a given time frame by an entity to a velocity classification; and importance comprises a low, medium, or high classification of importance of a resource on which an entity is operating, and importance is determined based one or more rules that map a device function to an importance classification.

In some embodiments, the approach includes applying the constraint solution to a group prioritization task to determine a group prioritization for a group of entities. For example, alerts for multiple entities in a group are used to determine the actor type(s), breadth, velocity, and importance where alerts for all members of the group are attributed to a single actor.

Approaches, are discussed below in the context of figures provided herein for purposes of illustration. In the following description, numerous specific details are set forth to provide a more thorough description. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items.

In some embodiments, network token/authorization traffic is examined to learn the token/authorization behavior associated with accounts, hosts, and services of a network by a threat classification platform. For example, alerts may be generated by various modules on a network and indicate activity on a network by entities/groups thereon (e.g., the accounts, hosts, or services). Such alerts may correspond to token/authorization requests/responses, to access of resources on a network, to movement of data on a network, and any other potentially relevant activities that are detectable from the hosts, services, and other resources on a network.

In some embodiments, a threat classification platform, or a part thereof, is at or connected to one or more switches or hosts operating an authentication service for capturing network token/authorization traffic. The threat classification platform can capture the network traffic by processing the traffic in line or by performing a zero-load copy operation(s). Furthermore, in some embodiments, the threat classification platform processes authentication service logs. In some embodiment, the authentication service logs and the network token/authorization traffic are stitched together prior to processing. In some embodiments, service logs can be processed in place of and to the exclusion of network traffic by the threat classification platform.

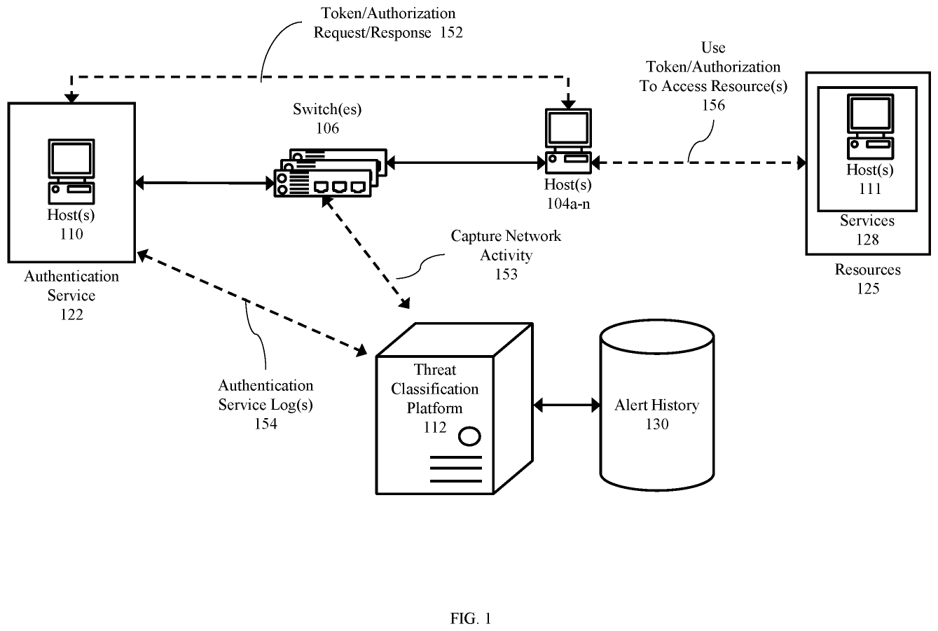

FIG. 1 illustrates an example environment(s) in which some embodiments of the invention are implemented. The figure illustrates relationships between hosts, an authentication service, a threat classification platform, an alert history storage, and resources.

As will be discussed further below, the threat classification platform operates on data transmitted over a network in alerts and/or extracted from network data such as token/authorization request/response data (see 152) and provided in one or more alerts. In some embodiments, the data comprises one or more of an account, a service, and a host associated with a particular access request of a plurality of access requests. Additional alerts can be provided by and transmitted over any number of modules on the network, such as on hosts, switches, firewalls, or at other services. The alerts can be maintained in storage (e.g., 130) comprising an alert history. The storage may comprise one or more devices which may be maintained separately or as part of a larger database. This information can be processed by the threat classification platform 112 to determine urgency corresponding to respective alerts—e.g., based on information received as part of respective alerts in view of historical information maintained in the alert history over a corresponding period of time.

Generally, services correspond to resources in a network. For instance, resources 125 comprise any number of resources accessed by hosts on a network. Furthermore, resources may comprise both services and traditional resources. For instance, services include email services, Structure Query Language (SQL) based services, etc. hosted by one or more host(s) 111. Traditional resources comprise accessible file systems such as network-based file shares that are accessible on a file-by-file basis via one or more protocols such as Common Internet File System (CIFS) or Server Message Block (SMB).

Access to the resources 125 is managed by an authentication service 122. In some embodiments, the authentication service 122 is implemented by one or more host(s) 110. The authentication service 122 maintains or has access to a dataset to determine which requests from which accounts should be provided a positive response (e.g., a token or authorization) to allow access to a requested resource. In some embodiments, the authentication service comprises a Microsoft “Active Directory” service or is accessible via the Kerberos authentication/authorization protocol, though one of ordinary skill in the art would understand that other similar services could be implemented.

To briefly illustrate, the Kerberos authentication/authorization protocol generally works as illustrated herein. Specifically, the Kerberos architecture usually contains the following systems: a client account operating from a client host, a service hosted on a service host, and a Kerberos Domain Controller (KDC) (see e.g., authentication service 122), which holds keys it shares with each client and service. The first step is for an account to authenticate itself with a realm (which can be thought of as a namespace) managed by the KDC. Once authenticated, using the secret shared by the client account and the KDC, the KDC provides the client account with a session key and a ticket granting ticket (TGT). This session key can be used for a predefined length of time as a “passport” inside the network. The TGT is encrypted with the KDC master key and is later used by the KDC for service authorization. This encryption scheme allows for stateless distributed deployments of KDC infrastructure. When the client account needs to access a service/application/host, it sends the session key, the TGT, and an access request to the KDC for the service. The KDC can decrypt the TGT using its master key, thereby ensuring that the TGT is authentic. Having completed the authentication phase, the KDC can then perform the authorization phase, which determines whether the client is allowed to access a particular service. Once the request passes this check, the KDC can construct and send a ticket granting service (TGS) reply to the client that is encrypted with both the client account session key and the service session key. Once the client receives the TGS, it can start to communicate directly with the service/host. The client sends the part of the TGS that was encrypted by the KDC with session key to the service/host. Once the service/host has used its own session key with KDC to verify the validity of the TGS, it knows that KDC has approved the client account to access the service it provides, and then gives access to the service to client account.

Communications between the authentication service and the host(s) 104a-n are exchanged over one or more switches 106. Generally, these communications are initiated by the host(s) 104a-n. A client host transmits a token/authorization request (see 152) on behalf of an account to the authentication service over one or more switches 106. The authentication service 122 will process the token/authorization request (see 152) to determine whether a token or authorization should be provided to the host. Depending on the result of that determination, the authentication service 122 will return a denial or a token/authorization granting the requested access at (see 152). If the token is provided to the host, (e.g., a host of host(s) 104a-n) the host will use the token/authorization to access the internal network resource 125 at 156.

In some embodiments, the threat classification platform 112 includes a sensing module(s) for capturing network activity which may include token/authorization requests and/or responses at 153 from one or more of switches 106 or authentication service 122. For instance, the threat classification platform 112, includes multiple distributed sensing modules (taps) located at different locations (e.g., switch(es) 106 and/or authentication service 122 host(s) 110). The sensing modules can identify relevant information for use by the remainder of the threat classification platform 112—e.g., process activity to determine whether an alert should be generated and if so generate such an alert which may include information such as a host corresponding to the request, a requested service, the associated account, a corresponding protocol, whether the communication is a request or a response, whether the request was granted or denied, the time of the request/response, or any other relevant information. In some embodiments, the sensing module(s) are not part of the threat classification platform but are otherwise used to capture relevant information that is then provided for use by the threat classification platform 112 in one or more alerts.

In some embodiments, only requests or responses are captured at 153. In some embodiments, both requests and responses are captured. Furthermore, in some embodiments, the threat classification platform 112 processes authentication service logs, (see 154) to generate one or more alerts. Usually, most token/authorization requests will occur directly over the internal network and thus be identifiable directly from network packets at one or more network devices (e.g., switches 106, or from host(s) 110 of authentication service 122). However, some requests will occur over encrypted connections (e.g., secure shell (SSH) or remote desktop protocol (RDP)) and can't be captured merely by observing packets at network devices. Instead, these encrypted connection authorization requests and responses are logged by the authentication service 122. Thus, the encrypted connection authorization requests and responses can be processed by parsing the authentication service log(s) at 154 to generate alerts. In some embodiments, authentication service logs are aggregated at a log collector (not illustrated) prior to being provided to the threat classification platform 112. In some embodiments, the authentication service log(s) are compared to previously captured network activity to remove/exclude duplicate communications and thus avoid analysis corresponding to the same request and/or response twice.

In some embodiments, the threat classification platform 112 is provided on one or more host(s) 110 of the authentication service 122, on one or more separate hosts, on the switch(es) 106, or any combination thereof. Further discussion of the operation of the threat classification platform 112 is provided below.

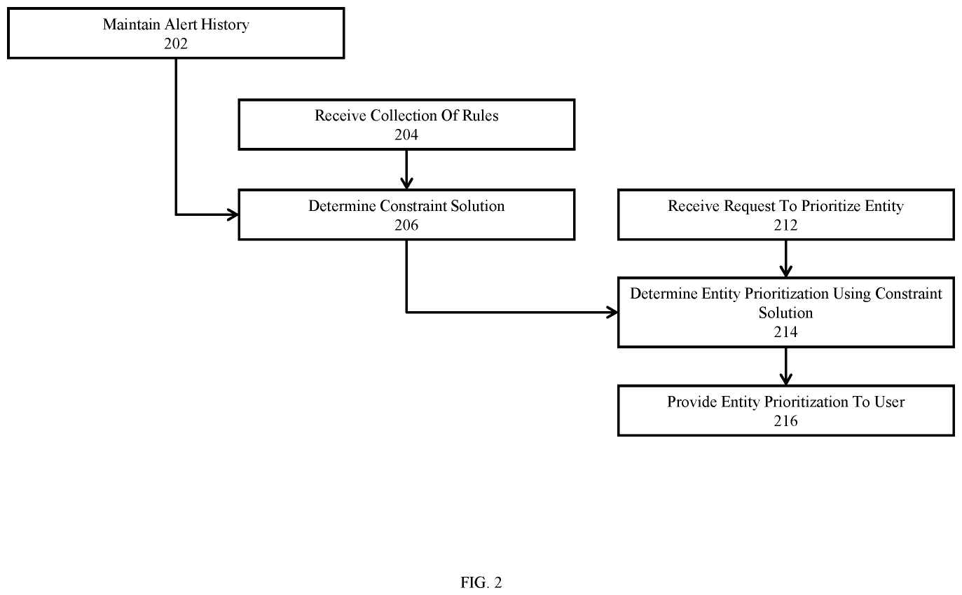

FIG. 2 illustrates a process flow according to some embodiments of the invention.

Generally, the process starts by maintain an alert history (see 202). For instance, each alert received over a given period of time is maintained in a database or other storage facility (see e.g., alert history 130). Such information may be maintained in a list, a linked list, a collection of database entries, a table, or a file. In some embodiments, the alerts are grouped by entity for faster searches. Regardless of the form used to maintain the alert history, data therein is processable by the threat classification platform to enable analysis corresponding to received alerts.

At 204 a collection of rules is received. In some embodiments, the collection of rules may be received at the same or a different time (including before) from maintaining the alert history. Generally, the collection of rules provide an association between a set of features and an output solution (e.g., urgency classification) which may include any of the rules (e.g., inequalities and results functions discussed herein). Each feature may be defined in any way as discussed herein. In some embodiments, the urgency classification corresponds to a number of ranges (e.g., 3), however, another approach could utilize a scoring mechanism in addition to or in place of the range/urgency classifications discussed herein. For instance, instead of expressly mapping the result to an urgency field, the results are an actual value that is found with or without regard to the thresholds that define the field boundaries, which could be mapped to ranges at a later time.

At 206, a constraint solution is determined. For example, a constraint solver may be provided to receive a collection of rules discussed herein and provide a solution where the solution enables processing of entities/groups based on at least additional alerts but without requiring that a new solution be provided by the constraint solver. One approach to do this would result in the constraint solver generating values or formulas representing how a contribution from each relevant feature is determined and/or treated.

At 212, a request is received to prioritize an entity/group with respect to a corresponding urgency of investigation. In some embodiments, the request is received for an individual entity/group in response to an event (e.g., a number, type, or characteristic of one or more alerts) or in response to an administrators request. In some embodiments, the processing of entities/groups is executed according to a given time frame or period (e.g., every second, minute, hour, day, week, or some number thereof). In some embodiments, the processing is triggered base on a number of alerts received (e.g., the process is triggered any time 100 alerts are received and pending analysis). In some embodiments, the period of a time window is specified and the entity/group prioritization is scheduled to be performed at or after the close of each successive time window.

At 214, an entity/group prioritization is calculated using the determined constraint solution. For instance, each feature value is determined of the entity/group and then processed to determine its contribution to a constraint solution which may then be mapped (e.g., by the constraint solution) to a particular classification (e.g., wait and watch, investigate, investigate immediately). Once the calculations are completed the results can be reported to a user at 216. For example, if a user specifically requested prioritization of a specific entity or group that prioritization could be presented to the user (e.g., in a graphical user interface) or could be used to update or add the entity/group prioritization to an existing set of entity/group prioritizations. In some embodiments, the entity/group prioritization request is for multiple entities/groups and the results are generated and presented as a collection instead of individually.

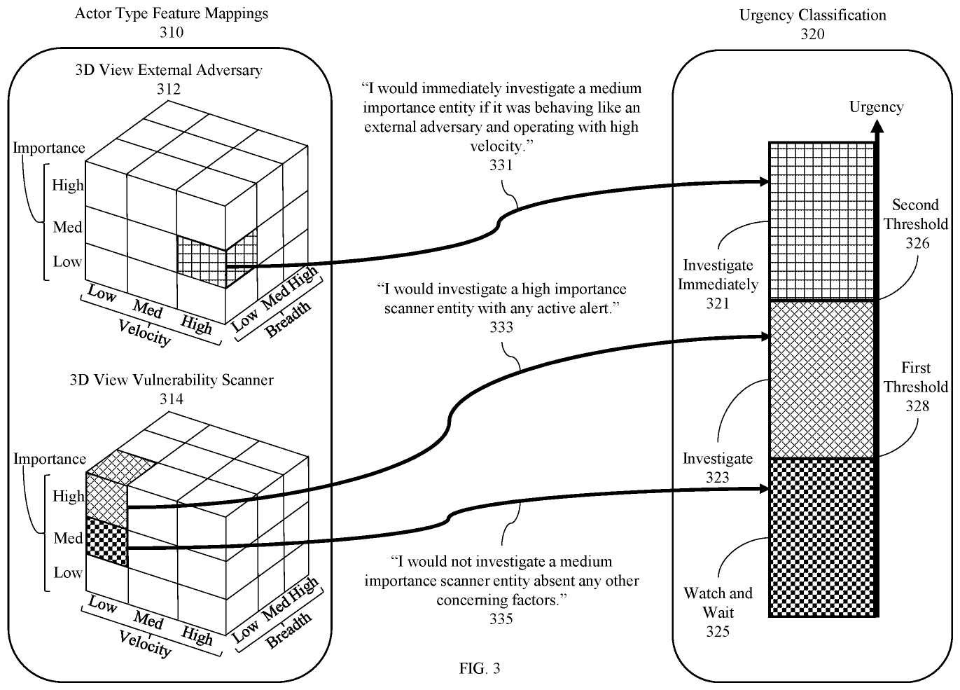

FIG. 3 provides logical illustration of the approach provided herein according to some embodiments of the invention. Generally, the illustrations provide a visual representation of aspects of the present approach according to a preferred embodiment.

At 310, actor type feature mappings are provided. Logically, the computing system will operate in a feature space with dimensions equal to the number of features. In some embodiments, additional dimensions may be used beyond the four discussed herein. However, multidimensional spaces are difficult to visualize, especially when there are more than three dimensions. Thus, the approach is illustrated here by separating the actor type feature from the remaining features (here importance, velocity, and breadth). In particular 312 provides a 3D view for the external adversary actor type. As shown each axis is divided into three ranges (low, medium, and high). The vulnerability scanner 3D view 314 is likewise provided.

At 320, an urgency classification is provided. The classification can be provided as three regions that map to different value ranges based on at least a minimum (e.g., 0), a maximum (not necessary to specify but could be set based on a highest possible result from the constraint solution), and two thresholds (first threshold 328 e.g., T₁ and second threshold 328 e.g., T₂). The regions may also correspond to a recommended action based on the classification. For example, a region from zero to the first threshold might be classified as the wait and watch region (see 325), a region from the first threshold to the second threshold might be classified as the investigate (see 323), and a region from the first threshold to a maximum might be classified as the investigate immediately region (see 321). As illustrated, entities/groups that fall within the investigate immediately region should be investigated as soon as possible, entities/groups that fall within the investigate region should be investigated eventually but after the investigate immediately region, entities/groups that fall within the watch and wait region are likely not worth investigating.

The quoted language at 331, 333, and 335 represent logic that could be converted into a form of an inequality that would be used by the constrain solver to determine a solution. Such a conversion might be performed by a person (e.g., an admin or person with knowledge). For instance, 331 recites “I would immediately investigate a medium importance entity if it was behaving like an external adversary and operating with high velocity.” This could be used to generate an inequality such as C1*medium Importance+C2*External Adversary+C3*High velocity>T₂. For 333 which recites “I would investigate a high importance scanner entity with any active alert.” An inequality might comprise T₂>c1*High Importance+C2*Vulnerability Scanner>T₁. At 335, the illustration recites “I would not investigate a medium importance scanner entity absent any other concerning factors.” A corresponding inequality might comprise T₁>c1*Medium Importance+c3*low velocity+c4*low breadth.

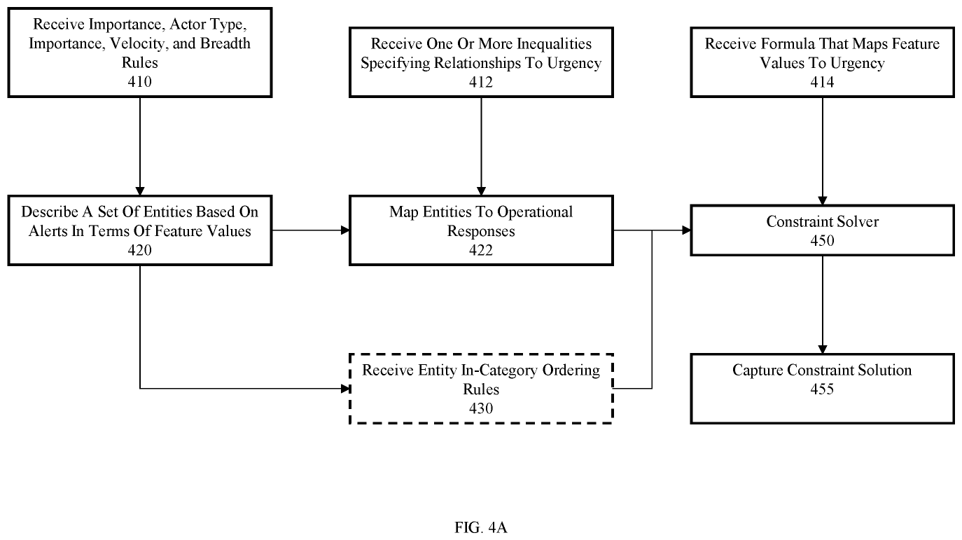

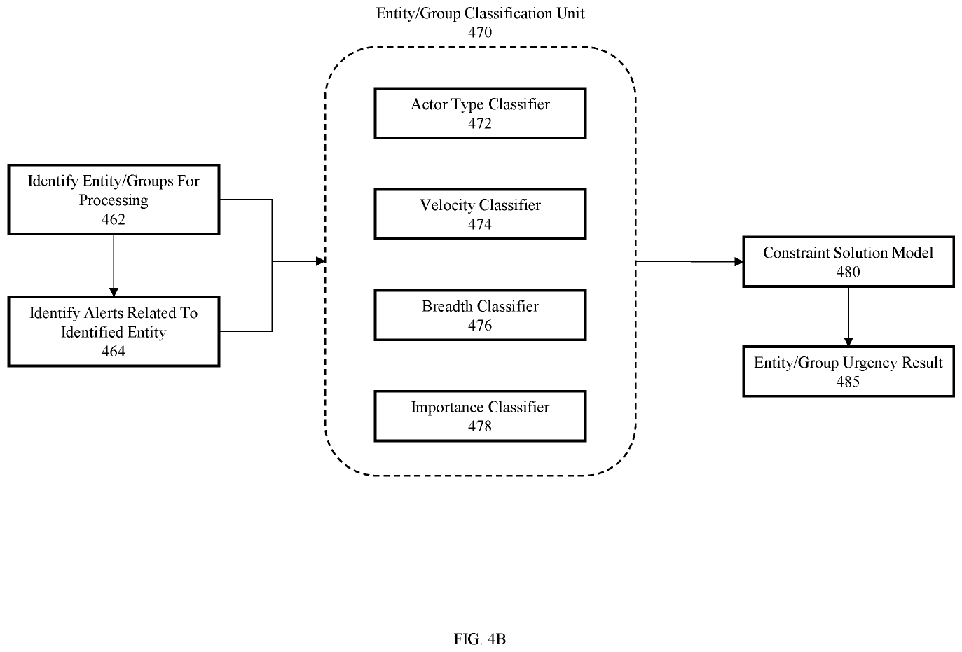

FIG. 4A illustrates an operational view of an approach to generate a constraint solution as provided herein according to some embodiments of the invention. While the approach illustrated herein separates out many aspects, the illustrated processes could be combined or separated into the same or different parts.

At 410 the set of rules is received that describe how to determine importance, actor type, velocity, and breadth. As discussed elsewhere in this application, these values can be either provided by another system or a domain expert (e.g., actor type and/or importance), or be provided based on a formula (see e.g., discussion of velocity and breadth rules herein). Once these rules have been received a set of entities/groups may be processed by describing those entities/groups in terms of feature values at 420. For instance, each entity/group might be described by an importance (low/medium/high), an actor type, a velocity (low/medium/high), and a breadth (low/medium/high). In some embodiments, multiple entities are grouped together where the group is treated as if it is a single entity for the purpose of determining the importance, actor type, velocity, and breadth.

At 412, one or more inequalities are received that specify a relationship to urgency based on at least some of the possible feature values. For instance, each unique combination, or a subset thereof, of the features may be associated with an urgency such as through use of a threshold (e.g., one or more of a relationship to a first or second threshold).

At 422 each entity/group may be mapped to an operational response (e.g., using the urgency). For example, to the extent possible each entity/group is associated with one or more of the inequalities received at 412 to create a unified set of a system of equations.

At 414, a formula that maps the features to the urgency is provided (e.g., Urgency(actor, velocity, breadth, importance)=c1*Importance+c2*actor type+c3*velocity+c4*breadth). At 450, the mapped entities/groups from 422 and the formula at 414 are input into the constraint solver. Constraint solvers are generally known in the art and therefore will be discussed only briefly. The constraint solver takes the system of equations (e.g., inequalities and the urgency function) and attempts to find values that can be used to map the entities/groups to the correct output. Assuming that a solution is identified, it is captured at 455—e.g., by storing the system or a representation thereof in a volatile or non-volatile storage device. As will be discussed below, the solution is useable to determine relative urgency values for entities/groups at some time in the future.

In some embodiments, additional rules are provided that indicate an ordering of entities/groups (see 430). For example, a rule might indicate that all other things being equal, a medium importance vulnerability scanner>high importance cloud service. A collection of such rules could be provided into the constraint solver, which when incorporated would dictate sorting of entities/groups within respective categories.

FIG. 4B illustrates an operational view of an approach to determine an urgency for an entity based on a constraint solution as provided herein according to some embodiments of the invention.

Generally, the process starts at 462, where an entity/group is identified for processing. For instance, the entity/group might be identified from a list of entities on a network. Additionally, the entity/group information is provided to a process at 464 to identify any alerts related to the identified entity/group. In some embodiments, multiple entities are combined into a group. For example, an action from one host to another might indicate that the other host is performing an action on behalf of the first. Such actions can be chained through many hosts. Similarly, an actor of one host might use this approach to hop from one host to the next collecting access rights along the way. Thus, actions from one host to another might indicate that the other host is now controlled by the first or by the individual or organization controlling the first. Thus, in some embodiments, detection rules are used to form hosts into a group for purposes of analysis of their corresponding alerts in aggregate. For each group, the feature values such as Actor Type, velocity, importance, breadth can be determined for a group of entities. For instance, if a host A triggers a port scan to a target host B, followed by a remote procedure call to the same target host B, after which host B triggers gathering of internal data and a SQL injection. Then the list of techniques triggered can be created for the group (Host A, Host B), and actor type, velocity, importance and breadth can be determined for this group.

In some embodiments, an entity/group classification unit is provided at 470. The entity/group classification unit might include one or more sets of logic to determine various value for features to be used by a constraint solution model. As illustrated, the entity/group classification unit 470 includes an actor type classifier 472, a velocity classifier 474, a breadth classifier 476, and an importance classifier 478.

The actor type classifier 472 provides a classification of an entity/group. In some embodiments, the collection of alerts deemed related because they share an entity or group of entities can be used as input to a classifier that assigns a behavioral profile, or actor type, to the collection. The actor type classifier may be a rules-based system (if A, B, and C are present, choose label X) or may be implemented using softer matching logic. For instance, each actor type (examples include “external adversary”, “insider threat”, and “vulnerability scanner”) might associated with a set of alert types based on input from domain experts. Subsequently, an input to the actor type classifier (a collection of related alerts) is assigned an actor type label based on which actor type has the largest fraction of alerts overlapping with the input set. In some embodiments, an actor type classifier applies multiple labels to the given entity/group (e.g., based on a threshold or based on a corresponding alert being identified.

Additionally, the velocity classifier 474 might be included to characterize the speed in which an entity/group is traversing the network (e.g., based on one or more rules or equations). In some embodiments, the timing between related alerts and characteristics of those alerts can be used to estimate the speed with which an attacker is traversing the network. For example, three alerts sharing a source entity, respectively describing port scanning, suspicious remote execution calls, and data exfiltration might be termed low-velocity, medium-velocity, or high-velocity depending on their relative timing. If the alerts spanned a time period of one week, the velocity classifier might label the attack low-velocity. Conversely, should the same three alerts trigger in the span of one hour, the velocity classifier might label the attack high-velocity.

Similar to the velocity classifier, the breadth classifier 476 might be provided to quantize a number of different types of activities engaged in by an entity/group. In some embodiments, the set of attack categories spanned by a collection of related alerts can used to produce a label describing the behavioral breadth of an attack. In one instance, three alerts sharing a high-level behavioral category (such as three alerts all related to reconnaissance) might be collectively be labeled low-breadth. Conversely, three alerts each affiliated with a different behavioral category (such as command & control, lateral movement, and data exfiltration) might be labeled high-breadth.

Finally, an importance classifier 478 might be provided to quantify the importance of a particular entity/group (e.g., based on a set of default rules and/or based on a specification of importance provided by an admin). In some embodiments, the importance can be determined based on at least asset classification information. For instance, a classifier can be used to determine if an entity/group is a domain controller, a file server, a backup machine, a normal regular employee laptop, or a mobile phone on a guest network. Based on this determination importance can be assigned to the entity/group (e.g., high importance for domain controller, file server, or backup machine; normal importance for regular employee laptop; low for mobile phone on the guest network). In some embodiments, a privilege score is determined for each entity or group thereof in the network based on their historical patterns (e.g., based on the level of privilege that those actions indicate where common activities such as authentication for access to email are lower privilege and rare activities so as remote desktop connection to a domain controller are higher privilege). The privilege score can then be used to determine importance values where high privilege scores implying access rights to high importance assets.

In some embodiments, the information from 462 and 464 are provided directly to the constraint solution model 480 which performs any necessary analysis and/or data retrieval to determine relevant feature values. In some embodiments output is provided by the entity/group classification unit 470 using any combination of 472, 474, 476, and 478. Constraint solution model 480 applies the values determined by the constraint solver to the features received to determine an entity/group urgency result at 485.

### System Architecture Overview

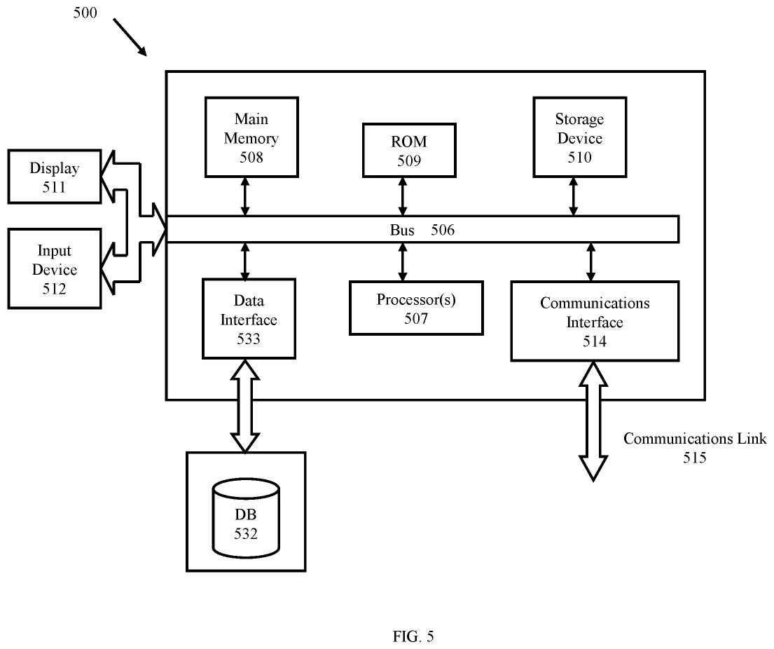

FIG. 5 is a block diagram of an illustrative computing system 500 suitable for implementing an embodiment of the present invention. Computer system 500 includes a bus 506 or other communication mechanism for communicating information, which interconnects subsystems and devices, such as processor 507, system memory 508 (e.g., RAM), static storage device 509 (e.g., ROM), disk drive 510 (e.g., magnetic or optical), communication interface 514 (e.g., modem or Ethernet card), display 511 (e.g., CRT or LCD), input device 512 (e.g., keyboard), and cursor control.

According to one embodiment of the invention, computer system 500 performs specific operations by processor 507 executing one or more sequences of one or more instructions contained in system memory 508. Such instructions may be read into system memory 508 from another computer readable/usable medium, such as static storage device 509 or disk drive 510. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 507 for execution. Such a medium may take many forms, including but not limited to, non-volatile media and volatile media. Non-volatile media includes, for example, optical or magnetic disks, such as disk drive 510. Volatile media includes dynamic memory, such as system memory 508.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 500. According to other embodiments of the invention, two or more computer systems 500 coupled by communication link 515 (e.g., LAN, PTSN, or wireless network) may perform the sequence of instructions required to practice the invention in coordination with one another.

Computer system 500 may transmit and receive messages, data, and instructions, including program, e.g., application code, through communication link 515 and communication interface 514. Received program code may be executed by processor 507 as it is received, and/or stored in disk drive 510, or other non-volatile storage for later execution. Computer system 500 may communicate through a data interface 533 to a database 532 on an external storage device 531.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method for translating entity prioritization rules to a continuous numerical space, comprising:
maintaining a plurality of alerts stored in an alert history;
receiving a collection of rules for determining urgency of entities;
determine a constraint solution for entity to urgency classification based on the collection of rules; and
applying the constraint solution to an entity prioritization task to determine an entity prioritization, wherein the entity prioritization task processes one or more alerts of the plurality of alerts corresponding to the entity.

2. The method of claim 1, wherein the collection of rules comprises inequality statements mapping one or more features to an entity prioritization, and the entity prioritization corresponds to the urgency classification.

3. The method of claim 2, wherein at least one of the inequality statements generated using latent semantic analysis based on a statement from a domain expert.

4. The method of claim 1, wherein the constraint solution is generated by a constraint solver that solves for the collection of rules, and the collection of rules associates one or more of an actor type, breadth, velocity, or importance to an urgency classification using one or more inequality statements.

5. The method of claim 4, wherein actor type comprises a characterization of a behavioral intent of an actor and is determined using one or more MITRE cyber-attack technique identifiers (T-numbers).

6. The method of claim 4, wherein breadth comprises a low, medium, or high classification of a diversity of behaviors of an entity and is determined using one or more equations that map a number of categories of alerts for a corresponding entity to a breadth classification.

7. The method of claim 4, wherein velocity comprises a low, medium, or high classification of how quickly an entity is triggering alerts and is determined using one or more equations that map a number of categories triggered in a given time frame by an entity to a velocity classification.

8. The method of claim 4, wherein importance comprises a low, medium, or high classification of importance of a resource on which an entity is operating, and importance is determined based one or more rules that map a device function to an importance classification.

9. The method of claim 1, further comprising applying the constraint solution to a group prioritization task to determine a group prioritization for a group of entities.

10. A non-transitory computer readable medium having stored thereon a set of instructions, the set of instructions, when executed by a processor, causing a set of acts or translating entity prioritization rules to a continuous numerical space, the set of acts comprising:
storing a plurality of alerts in an alert history;
receiving a collection of rules for determining urgency of entities;
determine a constraint solution for entity to urgency classification based on the collection of rules; and
applying the constraint solution to an entity prioritization task to determine an entity prioritization, wherein the entity prioritization task processes one or more alerts of the plurality of alerts corresponding to the entity.

11. The non-transitory computer readable medium of claim 10, wherein the collection of rules comprises inequality statements mapping one or more features to an entity prioritization, and the entity prioritization corresponds to the urgency classification, and at least one of the inequality statements generated using latent semantic analysis based on a statement from a domain expert.

12. The non-transitory computer readable medium of claim 10, wherein the constraint solution is generated by a constraint solver that solves for the collection of rules, and the collection of rules associates one or more of an actor type, breadth, velocity, or importance to an urgency classification using one or more inequality statements.

13. The non-transitory computer readable medium of claim 12, wherein actor type comprises a characterization of a behavioral intent of an actor and is determined using one or more MITRE cyber-attack technique identifiers (T-numbers).

14. The non-transitory computer readable medium of claim 12, wherein breadth comprises a low, medium, or high classification of a diversity of behaviors of an entity and is determined using one or more equations that map a number of categories of alerts for a corresponding entity to a breadth classification.

15. The non-transitory computer readable medium of claim 12, wherein velocity comprises a low, medium, or high classification of how quickly an entity is triggering alerts and is determined using one or more equations that map a number of categories triggered in a given time frame by an entity to a velocity classification.

16. The non-transitory computer readable medium of claim 12, wherein importance comprises a low, medium, or high classification of importance of a resource on which an entity is operating, and importance is determined based one or more rules that map a device function to an importance classification.

17. The non-transitory computer readable medium of claim 10, further comprising applying the constraint solution to a group prioritization task to determine a group prioritization for a group of entities.

18. A computing system for translating entity prioritization rules to a continuous numerical space comprising:
a memory storing a set of instructions; and
a processor to execute the set of instructions to perform a set of acts comprising:
storing a plurality of alerts in an alert history;
receiving a collection of rules for determining urgency of entities;
determine a constraint solution for entity to urgency classification based on the collection of rules; and
applying the constraint solution to an entity prioritization task to determine an entity prioritization, wherein the entity prioritization task processes one or more alerts of the plurality of alerts corresponding to the entity.

19. The computing system of claim 18, wherein the collection of rules comprises inequality statements mapping one or more features to an entity prioritization, and the entity prioritization corresponds to the urgency classification, and at least one of the inequality statements generated using latent semantic analysis based on a statement from a domain expert.

20. The computing system of claim 18, wherein the constraint solution is generated by a constraint solver that solves for the collection of rules, and the collection of rules associates one or more of an actor type, breadth, velocity, or importance to an urgency classification using one or more inequality statements.
